(19) United States
(12) Patent Application Publication
(10) Pub. No.: US 2014/0358766 A1
(43) Pub. Date: Dec. 4, 2014

(54) SYSTEMS AND METHODS FOR IMPLEMENTING MERCHANT WORKING CAPITAL

(71) Applicant: EBAY INC., San Jose, CA (US)

(72) Inventors: Ashish Nayyar, San Jose, CA (US); Brian Grech, San Jose, CA (US); Brian M. Hale, San Jose, CA (US)

(73) Assignee: EBAY INC., San Jose, CA (US)

(21) Appl. No.: 14/189,413

(22) Filed: Feb. 25, 2014

Related U.S. Application Data
(60) Provisional application No. 61/829,815, filed on May 31, 2013.

(51) Int. Cl. G06Q 40/02

(52) U.S. Cl. CPC G06Q 40/025
USPC 705/38

(57) ABSTRACT

A system or method for implementing working capital for merchants is provided. In particular, a payment service provider may provide working capital to merchants based on the merchant's sales or payment history. For example, based on a merchant's sales or payment history, a close-ended (fixed amount) loan based on expected customer sales, with no fixed duration, no end date, and no interest, is provided to the merchant The “loan” may be viewed as a hybrid cash advance/loan product. Further, the repayment for the loan may be derived from future sales. The payment service provider may monitor sales volume of the merchant based on payment activities at the merchant. Based on the loan term, a portion of the sales revenue of the merchant may be directed for repayment of the loan. Thus, the repayment may be contingent on sales volume to provide the merchant with flexibility in loan repayment.

### CROSS REFERENCE TO RELATED APPLICATION

Pursuant to 35 U.S.C. §119(e), this application claims priority to the filing date of U.S. Provisional Patent Application No. 61/829,815, filed on May 31, 2013, which is incorporated by reference in its entirety.

### BACKGROUND

1. Field of the Invention

The invention relates generally to systems and methods for implementing working capital for merchants.

2. Related Art

Merchants typically need capital or funding at various times to build, expand, sustain, or save their business. Current lending/capital advance products tailored to SMBs (small and medium businesses) may not be desirable to a very large market of SMBs. The five largest U.S. banks hold approximately 40% of all domestic deposits, yet make only 16% of all business loans with balances of $1 million or less.

Typically, business owners are drawn into bank branches by a deposit relationship or credit marketing, only to be met with a bureaucratic and slow loan process that consumes time and requires significant business and personal financial documentation and approval from layers of decision-makers. Some merchants may not have the necessary credit or history to receive a loan from a bank. Further, the bank may offer small or medium sized merchants with loan terms that have excessive interest rates or fees. The process also results in high rejection rates. In fact, 73% of small business owners who need a loan don't bother to apply for one, often because they believe their business lacks the financial history necessary for bank loan approval. One primary alternative to bank business loans for entrepreneurs in recent years has been the home equity loan. But as home values have fallen, many banks have pulled back on home equity lending. As a result, many small business owners turn to consumer credit products or private money for funding (when available) or simply give up on securing the capital they need to grow.

Even in times of expansion, banks' lending processes may not be friendly to small or new businesses, because it is not economical to devote a trained credit professional to evaluating loan applications for amounts less than $50,000. Therefore, there is a need for systems and methods that implement easy, convenient, flexible merchant cash advance products with transparent terms for merchants.

### BRIEF DESCRIPTION OF THE FIGURES

FIG. 1 is a block diagram of a networked system suitable for implementing merchant working capital according to an embodiment.

FIG. 2 is a flowchart illustrating a method for loan application according to an embodiment.

FIG. 3 is a flowchart illustrating a method for loan repayment according to an embodiment.

FIG. 4 is a block diagram of a computer system suitable for implementing one or more components in FIG. 1 according to one embodiment of the present disclosure.

FIG. 5 is an exemplary user interface introducing a loan product according to an embodiment.

FIG. 6 is another exemplary user interface introducing a loan product according to an embodiment.

FIG. 7 is yet another exemplary user interface introducing a loan product according to an embodiment.

FIG. 8 is still another exemplary user interface introducing a loan product according to an embodiment.

FIG. 9 is yet still another exemplary user interface introducing a loan product according to an embodiment.

FIG. 10 is an exemplary user interface introducing a loan application process according to an embodiment.

FIG. 11 is an exemplary user interface for entering merchant information in a loan application process according to an embodiment.

FIG. 12 is an exemplary user interface for selecting loan terms in a loan application process according to an embodiment.

FIG. 13 is an exemplary user interface for reviewing and accepting loan terms in a loan application process according to an embodiment.

FIG. 14 is an exemplary user interface for making a loan repayment according to an embodiment.

FIG. 15 is an exemplary user interface presenting a loan summary according to an embodiment.

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION

In one embodiment, a system or method for implementing working capital for merchants are provided. In particular, a payment service provider may provide working capital to merchants based on the merchant's sales or payment history. For example, based on a merchant's sales or payment history, a close-ended (fixed amount) loan based on expected customer sales, with no fixed duration, no end date, and no interest, is provided to the merchant. The “loan” may be viewed as a hybrid cash advance/loan product. Further, the repayment for the loan may be derived from future sales. The payment service provider may monitor sales volume of the merchant based on payment activities processed through the payment service provider. Based on the loan term, a portion of the sales revenue of the merchant may be directed for repayment of the loan. Thus, the repayment may be contingent on sales volume to provide the merchant with flexibility in loan repayment.

In one embodiment, the payment service provider may offer loan terms based on a merchant's sales, payments, and/or cash flow. For example, the amount of loan offered to a merchant may be a percentage of a merchant's annual sales revenue processed through the payment service provider. In one embodiment, a merchant may select an amount to borrow up to a maximum amount and may select a percentage of future sales processed through the payment provider service as repayment for the loan. Further, a single fixed fee may be assessed based on the amount, repayment percentage, past business sales volumes, and risk score. Thus, the fee amount is known by the customer before loan amount is funded. Additional fees, such as origination, utilization, pre-payment late fees, may not be imposed to simplify the loan terms.

The payment service provider may periodically determine the sales revenue of the merchant and transfer the designated percentage of the sales revenue to repayment until the loan amount plus the fee amount are paid in full. In addition, a merchant may make ad hoc payments with no penalty. In one embodiment, the payment service provider may offer the merchant with a second loan when the first loan is paid in full.

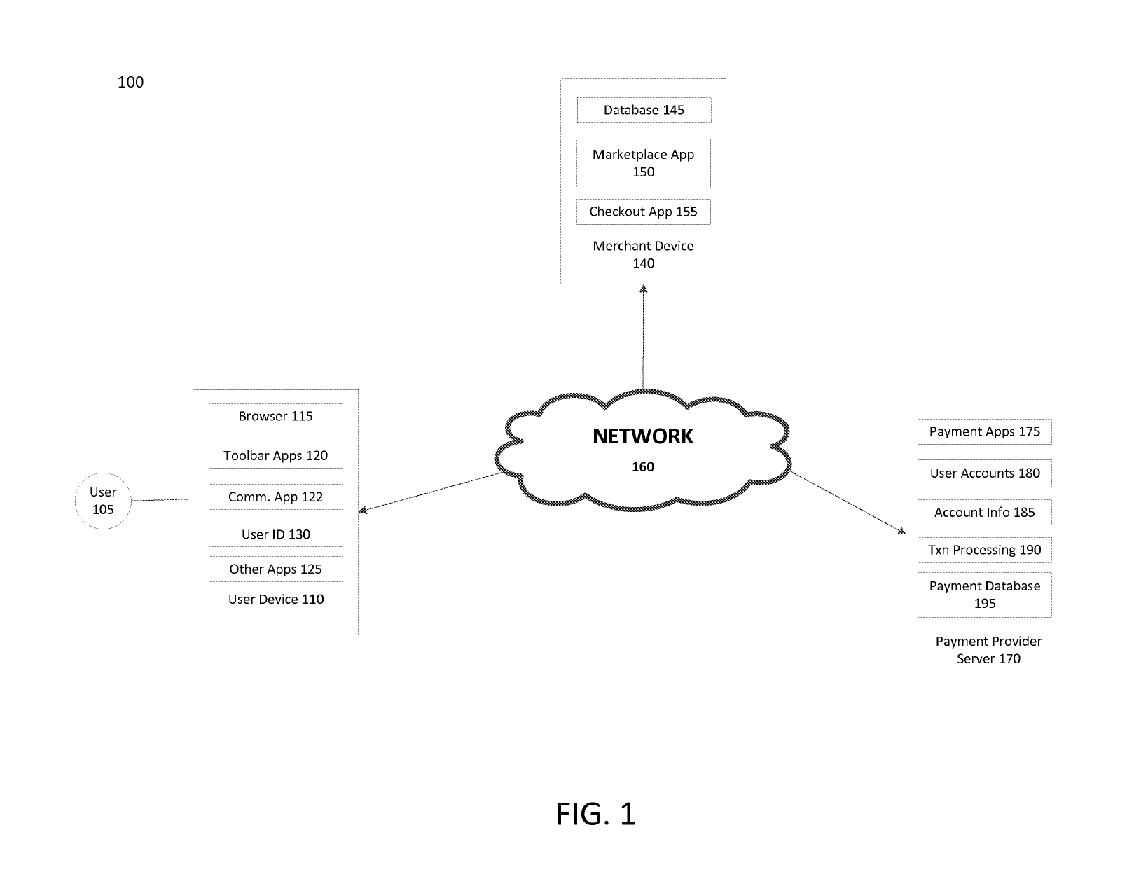

FIG. 1 is a block diagram of a networked system 100 suitable for implementing working capital for merchants according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a sender or consumer, utilizes user device 110 to perform a transaction using payment provider server 170. User 105 may utilize user device 110 to initiate a payment transaction, receive a transaction approval request, or reply to the request. Note that transaction, as used herein, refers to any suitable action performed using the user device, including payments, transfer of information, display of information, etc. For example, user 105 may utilize user device 110 to initiate a deposit into a savings account. Although only one user device is shown, a plurality of user devices may utilize the payment service provider to make purchase at the merchant.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, personal digital assistant (PDA), laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate, transfer information, make payments, and otherwise utilize a smart wallet through the payment provider as discussed above. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant server 140 may be maintained, for example, by a merchant or seller offering various products and/or services. The merchant may have a physical point-of-sale (POS) store front. The merchant may have a merchant account with the payment service provider. Merchant server 140 may be used for POS or online purchases and transactions. Generally, merchant server 140 may be maintained by anyone or any entity that receives money, which includes charities as well as banks and retailers. For example, a payment may be a donation to charity or a deposit to a saving account. Merchant server 140 may include a database 145 identifying available products (including digital goods) and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 includes one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In some embodiments, payment provider server 170 may maintain a sales transaction database storing sales transaction history of various merchants. The sales transaction history may include sales revenue, sales volume, types of sales, time, and location of various sales transactions processed through payment provider server 170. Payment provider server 170 may analyze the sales transaction history to determine and offer loan terms to a merchant.

Payment provider server 170 also may maintain a loan database storing loan accounts of various merchants or customers who had taken a loan from the payment service provider. The loan accounts may store loan information such as, a loan amount, repayment terms, projected payoff date, current loan balance, and the like. Thus, payment provider server 170 may monitor and keep track of various loan accounts and their repayment progress.

Payment provider server 170 may maintain a credit/risk database storing credit/risk information of various merchants or customers. The credit/risk information may include sales or purchase history, payment history, transaction volume, credit scores, types of funding sources, and the like. The credit/risk information may be used to determine loan terms for the merchants or customers.

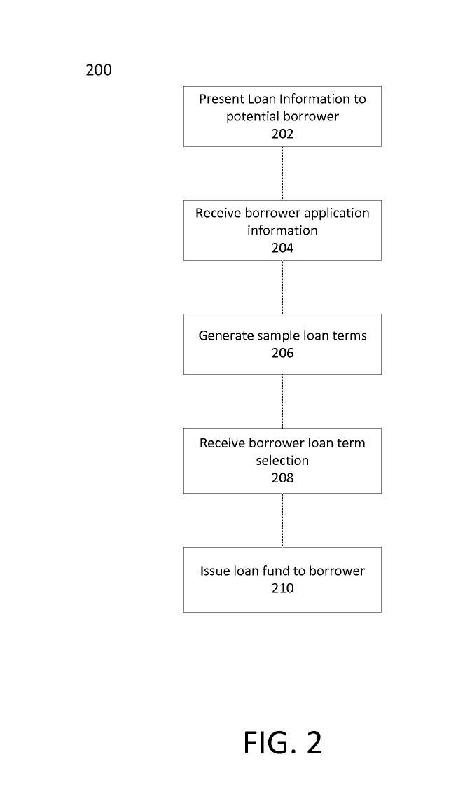

FIG. 2 is a flowchart illustrating a process 200 for loan application according to an embodiment of the invention. Process 200 may be executed by payment provider server 170 or a computer or server of a payment service provider. At step 202, payment provider server 170 may present loan information to a merchant or a customer. The loan information may be presented in an email, a website, or a display terminal. For example, payment provider server 170 may send an email including the loan information or a link to a website presenting the loan information. In another example, display terminals installed at public places may be used to present the loan information to potential customers or merchants. This information may be presented in response to a merchant request for a possible loan, which can be from a web page or an app of a payment service provider associated with an account of the merchant with the payment service provider or on a non-user specific web page or mobile screen.

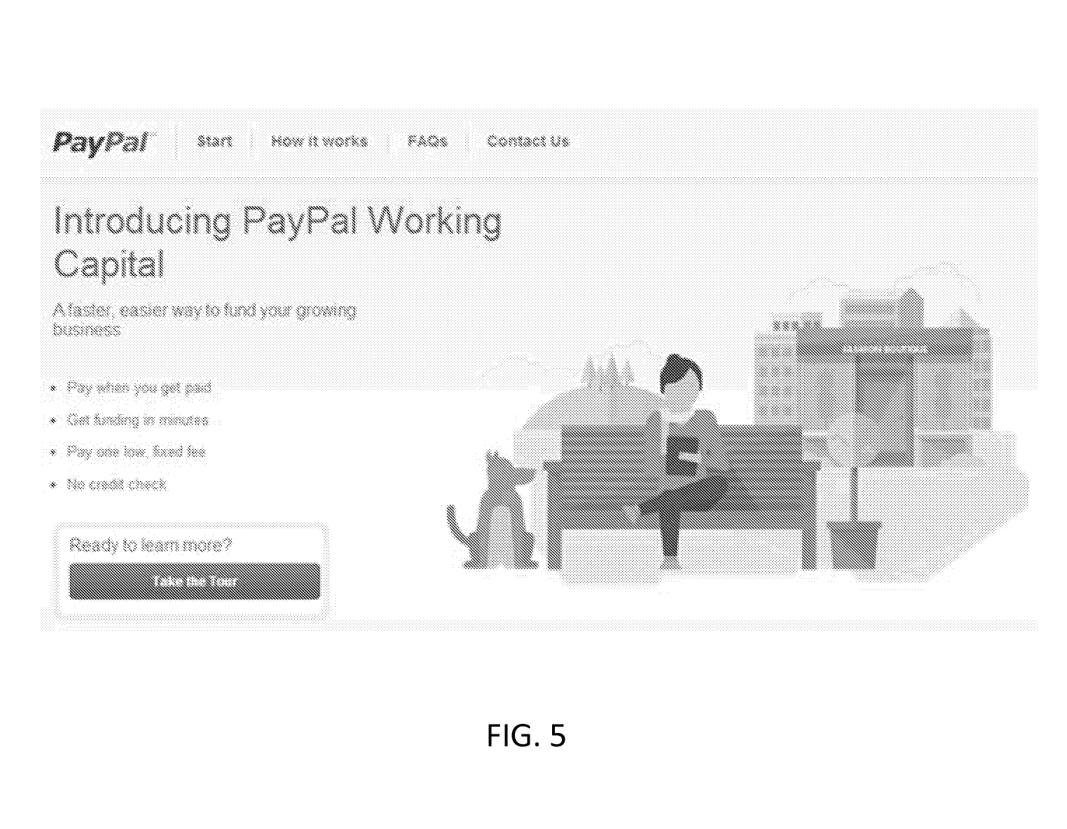

The loan information may provide an introduction to potential customers or merchants and may entice them to apply for a loan from the payment service provider. FIGS. 5-11 are exemplary screen shots that a potential borrower may see as part of an information tour provided by the payment service provider. Note that one or more of the features shown in the screen shots may be omitted as desired and additional features not in the screen shots may be part of the loan informational tour.

For example, FIG. 5 illustrates an initial screen display introducing loan products from a payment service provider, such as PayPal, Inc. The initial screen display may describe benefits of the loan products, such as fast and easy application process, sales revenue based repayment terms, fast funding, low and fixed fee, and no credit check. The initial screen display also may include a button or a link by which a potential customer or merchant may use to take a virtual tour of the loan products offered by the payment service provider.

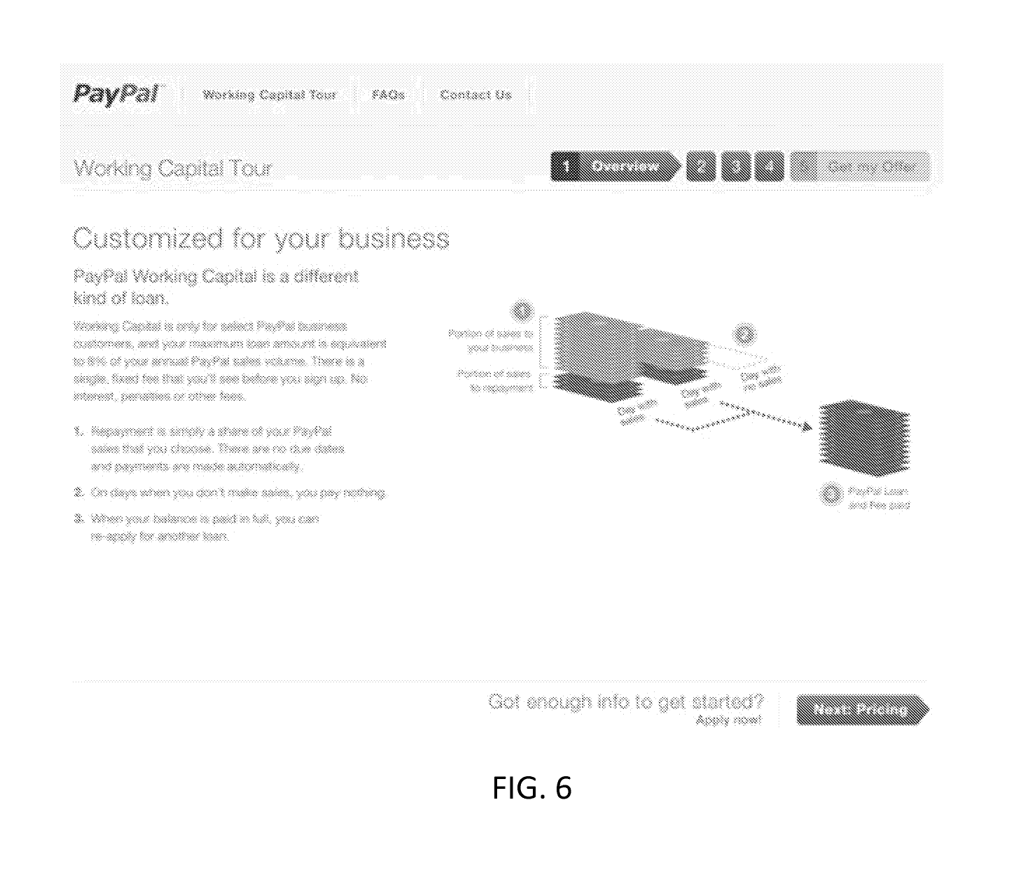

FIG. 6 illustrates an exemplary first screen of the loan product tour. The first screen may introduce the basic loan terms, such as that the loan amount is determined by sales volume, e.g., 8% of the annual sales volume, that there is one fixed fee, no interest or penalties, and that the repayment is sales volume based. Further, a new loan may be applied when a previous loan is paid in full. The first screen also may include graphical illustrations of a fixed percentage of daily sales revenue which is used for repayment. On days that have no sales revenue, no repayment is made.

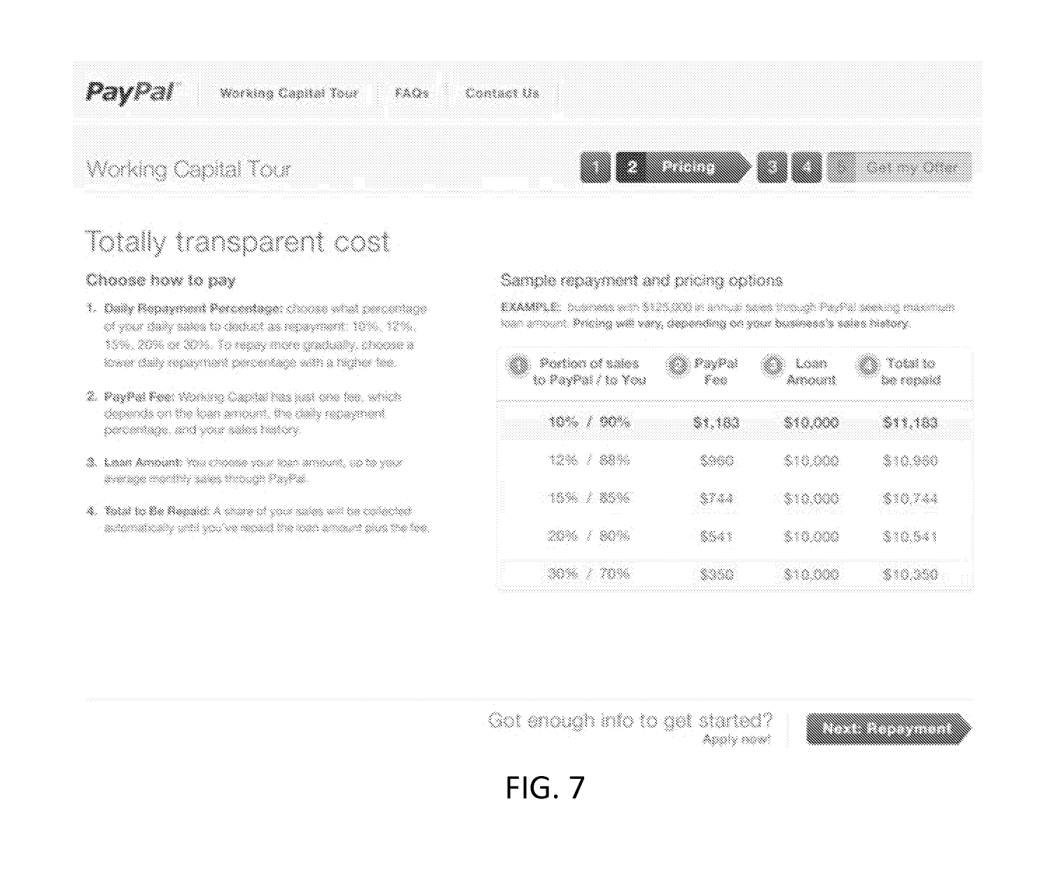

FIG. 7 illustrates an exemplary second screen of the loan product tour. The second screen may present how the price or cost of the loan is determined. For example, a sample repayment and pricing options may be presented as a table to illustrate different repayment and pricing options. A customer or merchant may select a percentage of daily sales revenue as the repayment. Further, the one-time fixed fee may be determined based on the loan amount, the daily repayment percentage and sales history. For example, a lower daily repayment percentage may correspond to a higher fee. The customer or merchant may choose a loan amount up to a maximum amount. In addition, a total amount to be repaid is listed at a last column to illustrate the total cost of the loan product.

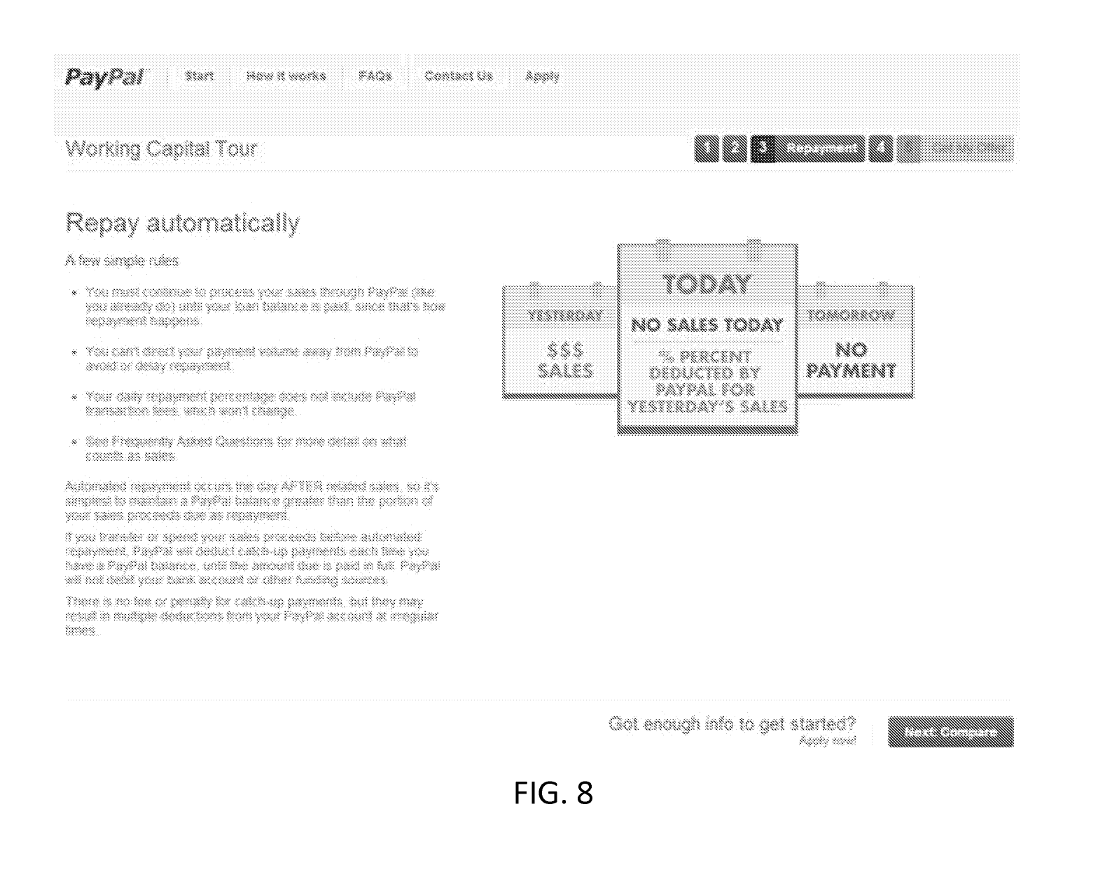

FIG. 8 illustrates an exemplary third screen of loan product tour. The third screen may present the repayment terms and processes. In particular, the repayments are automatically processed by the payment service provider. The loan terms may include several conditions that the borrower are to follow, such as continuing to process sales payment through the payment service provider and not directing sales payment volume away from payment service provider. Other terms indicate that the repayment percentage does not include transaction fees. The automated repayment may occur a day after the related sales occur. If the proceeds of sales are spent, payment service provider may deduct catch-up payments. Further, no fees or penalties are imposed for catch-up payments. A graphical calendar is presented to illustrate that a percentage of the sales revenue from yesterday may be used as repayment for today. As shown in the graphical calendar, if no sales occurred today, no repayment is made tomorrow.

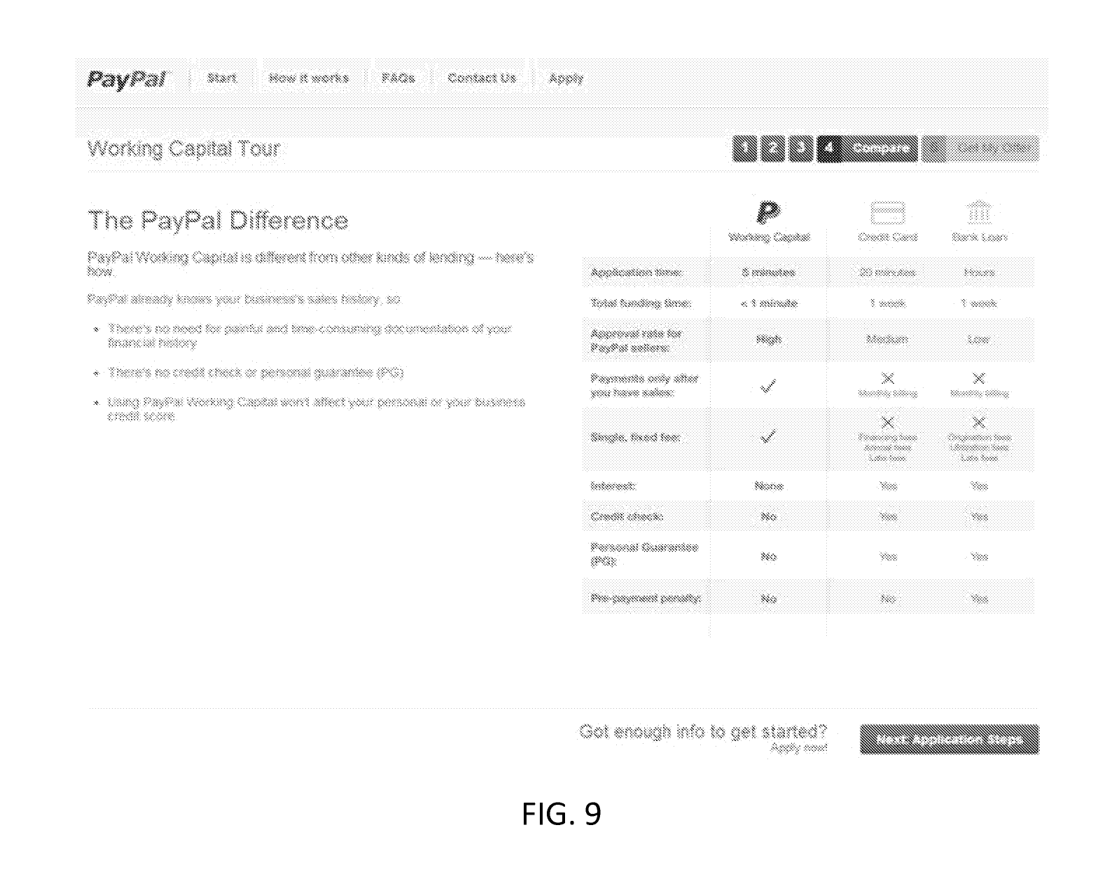

FIG. 9 illustrates an exemplary fourth screen of loan product tour. The fourth screen may present a comparison table comparing the payment service provider's loan product with other loan products. The comparison table may include application time, funding time, approval rate, repayment terms, fees, interests, credit check, personal guarantee, and pre-payment penalty. The comparison table may illustrate that the payment service provider's loan product has easy and fast application process, quick funding, high approval rate, single fixed fee, no interest, no credit check requirement, no personal guarantee requirement, and no pre-payment penalty. Thus, the payment service provider's loan product does not affect a loan borrower's personal or business credit score. Further, a button or a link may be provided on the fourth screen that allows a customer or a merchant to begin a loan application process.

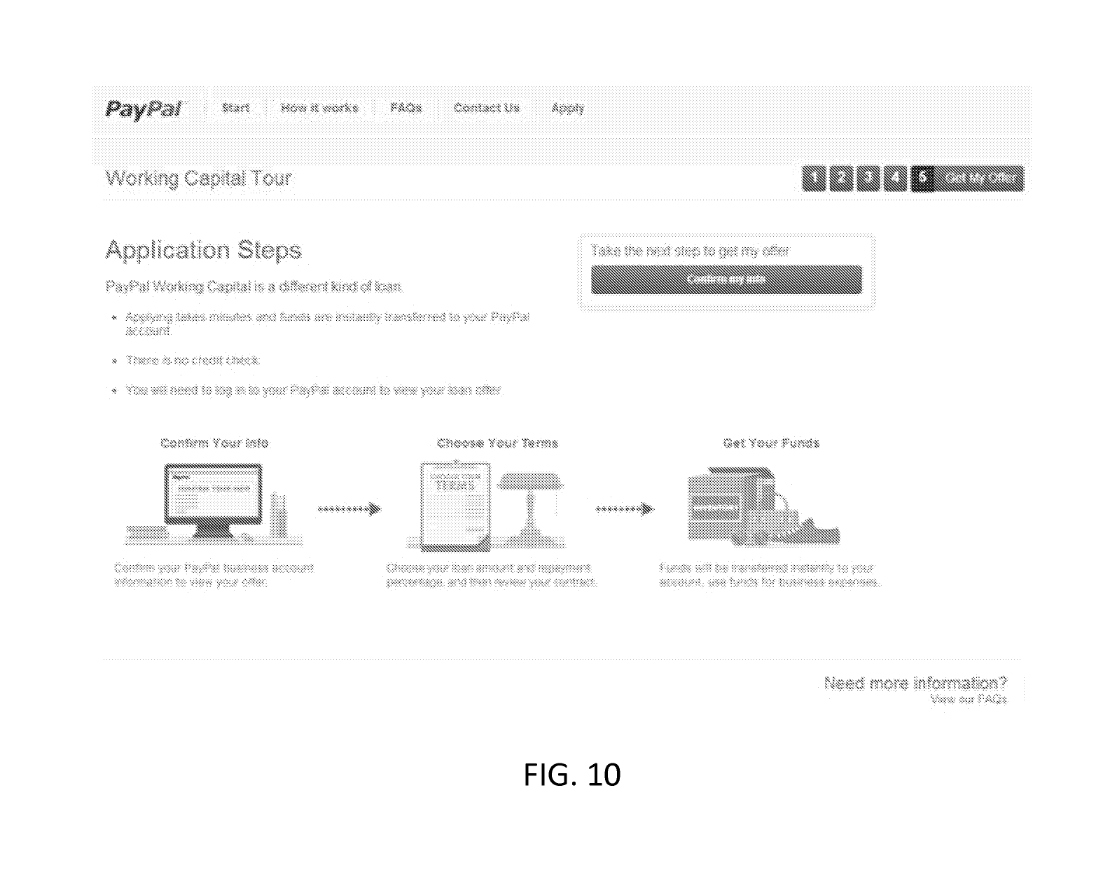

If a customer or a merchant decides to begin the loan application process, a fifth screen of loan product tour may be displayed to introduce a summary of the loan application process, as shown in FIG. 10. The loan application process may include steps such as: confirm your information, choose your terms, and get your funds. The application process may take several minutes and the loan funds may be transferred to the customer or the merchant's payment account immediately after the application is approved.

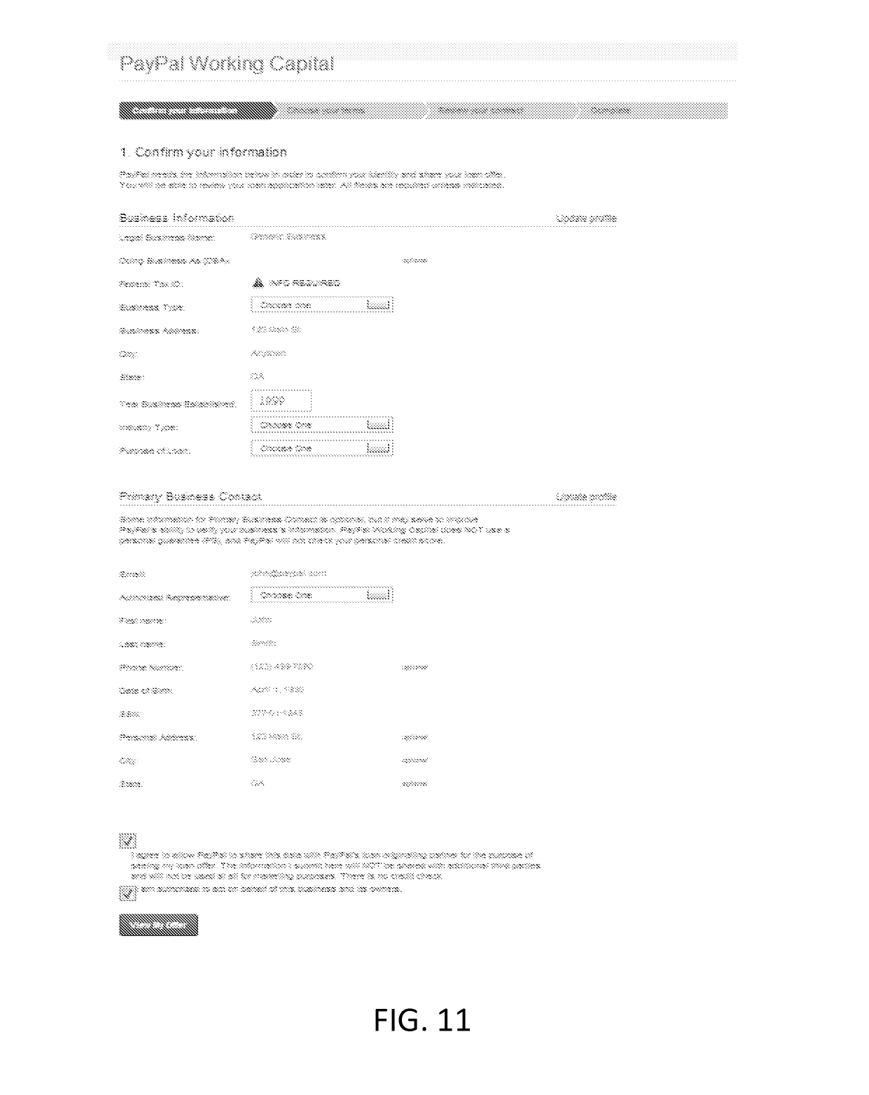

At step 204, payment provider server 170 may receive loan application information from a customer or a merchant, e.g., the borrower. For example, a customer or a merchant may use user device 110 or merchant device 140 to apply for a loan from the payment service provider. Payment provider server 170 may begin the loan application process by requesting information from the customer or merchant. For example, an information form with fill-in areas may be presented to the customer or merchant at user device 110 or merchant device 140 to receive information from the customer or merchant. Certain information may be prefilled based on existing knowledge of the merchant, such as based on information associated with the merchant's account with the payment service provider. Prefilled information may be changed by the merchant if not correct. FIG. 11 illustrates an exemplary information form for receiving information from the customer or merchant. The information form may receive business information of the business for which the loan is to be used for.

As shown in FIG. 11, the information form may collect business information, such as business name, federal Tax ID, business type, address, year of establishment, industry type, and purpose of loan. The information form also may include the primary business contact information, such as information of the business owner. The primary business contact information may include an email address of the business owner, name of the business owner, birth date, social security number, address, and the like.

In some embodiments, a merchant may already have a merchant account with the payment service provider. As such, payment service provider may already have all the merchant's information and the merchant may simply log into the merchant's account and skip the information entry process of step 204, assuming the information is all correct.

At step 206, payment provider server 170 may generate sample loan terms to be selected by the customer or merchant. The loan terms may be generated based on the customer or merchant's sales history, payment history, cash flow history, and/or other transactions processed by the payment service provider. For example, a qualified maximum loan amount may be determined based on a merchant's annual sales revenue. Payment provider server 170 may look up the annual sales revenue of a merchant for the past three years and may average them to determine an average annual sales revenue. Payment provider server 170 may use a percentage, e.g., 8%, of the average annual sales revenue as the maximum loan amount allowed to be borrowed by the merchant. The qualified maximum loan amount also may be adjusted based on consistency of annual sales revenue, length of merchant history, type of merchant business, credit rating, customer rating, and the like. For example, the qualified maximum loan amount may be increased if the merchant has a long history of consistent annual sales revenue or has good credit and/or customer ratings. Thus, loan terms may vary between merchants, depending on various factors, such as those discussed above.

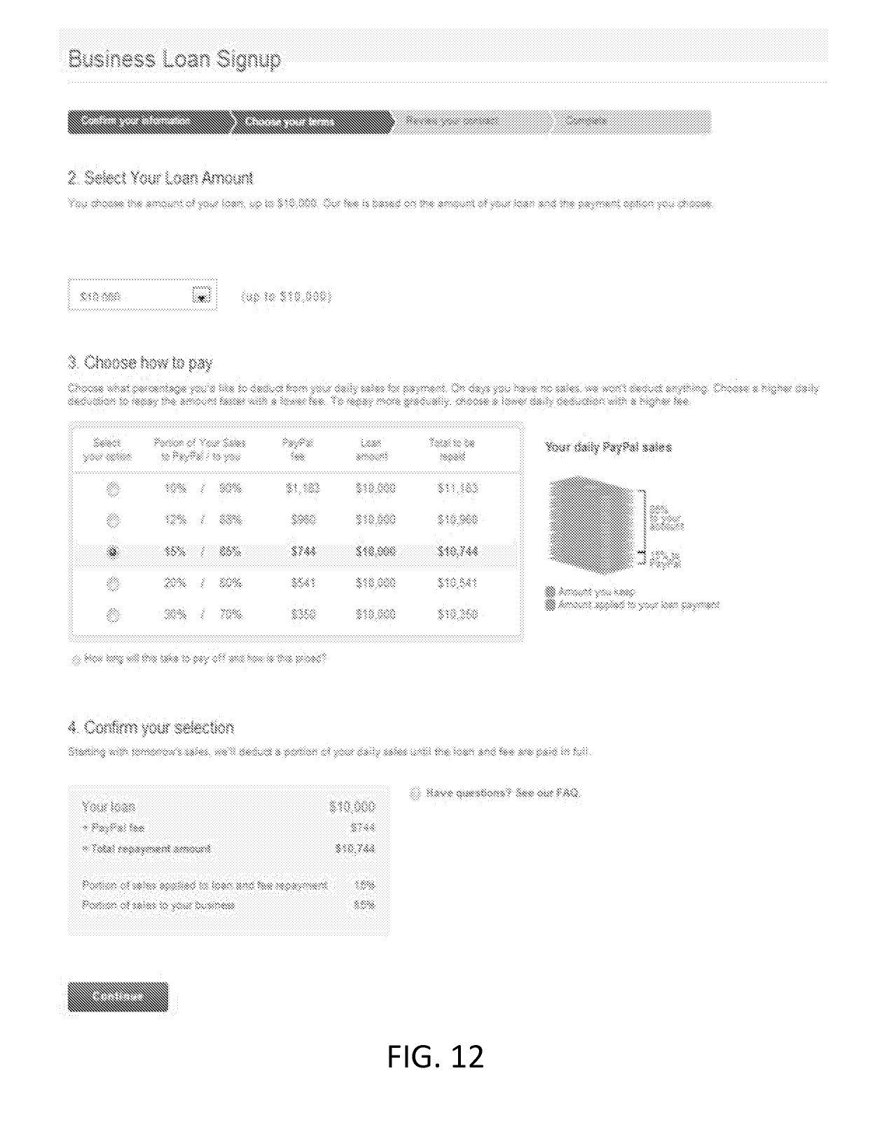

After the qualified maximum loan amount is determined, payment provider server 170 may present the maximum loan amount to the customer or the merchant. The customer or the merchant may enter a desired loan amount up to the maximum loan amount. FIGS. 10-15 are exemplary screen shots that illustrate a process a merchant goes through for applying for and obtaining a loan according to one embodiment. As discussed above, FIG. 10 includes a button or link a merchant can select to initiate the loan approval process, and FIG. 11 shows some initial information the merchant can confirm and/or fill in to start the process. FIG. 12 illustrates an exemplary screen for receiving selections for loan terms. A fill-in space is provided for the customer or the merchant to enter or select a loan amount. The maximum loan amount, e.g., $10,000, is indicated next to the fill-in space.

Payment provider server 170 also may generate different options for repayment. Each repayment option may indicate a percentage of sales revenue designated for repayment, a one-time loan fee, a loan amount, and a total repayment. Each repayment option may have a different one-time loan fee. Payment provider server 170 may determine the one-time loan fee based on the percentage of sale revenue for repayment, the credit/risk score of the borrower, the loan amount, and the like. For example, a smaller percentage of sales revenue for repayment may correspond to a higher one-time loan fee. Further, borrowers with higher risk or lower credit rating may correspond to a higher one-time loan fee. Merchants with a longer and consistent sales revenue history may be given a lower one-time loan fee.

If the borrower is not qualified for any types of loans based on the borrower's credentials, payment provider server 170 may inform that no loans are available due to a specific reason, such as lack of transaction history, lack of extensive sales history, or the like. Thus, the borrower may have a reason and continue to build the borrower's credential to be qualified for loans in the future.

As shown in FIG. 12, at least five different repayment options are determined and presented to the borrower. For example, the first option has a 10%/90% arrangement, in which 10% of the borrower's sales revenue would be used for repayment to the loan. As the percentage for repayment increases in the second, third, fourth, and fifth options, the one-time loan fee may decrease. A graphical representation of the repayment percentage may be presented to the borrower to help borrower visualize the sales revenue v. repayment ratio. In some embodiments, based on the borrower's past sale revenue, a projection of repayment schedule may be presented to the borrower to predict how long and when the loan is expected to be paid off. Any number of options may be presented, again depending on merchant information. In other embodiments, the same number and/or options are presented to all potential borrowers or to certain groups of potential borrowers sharing one or more common traits or characteristics. In another embodiment, the potential borrower may set its own terms, which the payment service provider may accept, decline, or revise.

At step 208, payment provider server 170 may receive the user or merchant's selections of various loan terms. For example, the user or merchant may enter a loan amount of $10,000 and select a repayment option of 15%/85% with a one-time loan fee of $744 for a total amount of $10,744, which is to be paid off by 15% percent of future sales revenue. A summary of the selected loan terms may be presented to the borrower for confirmation.

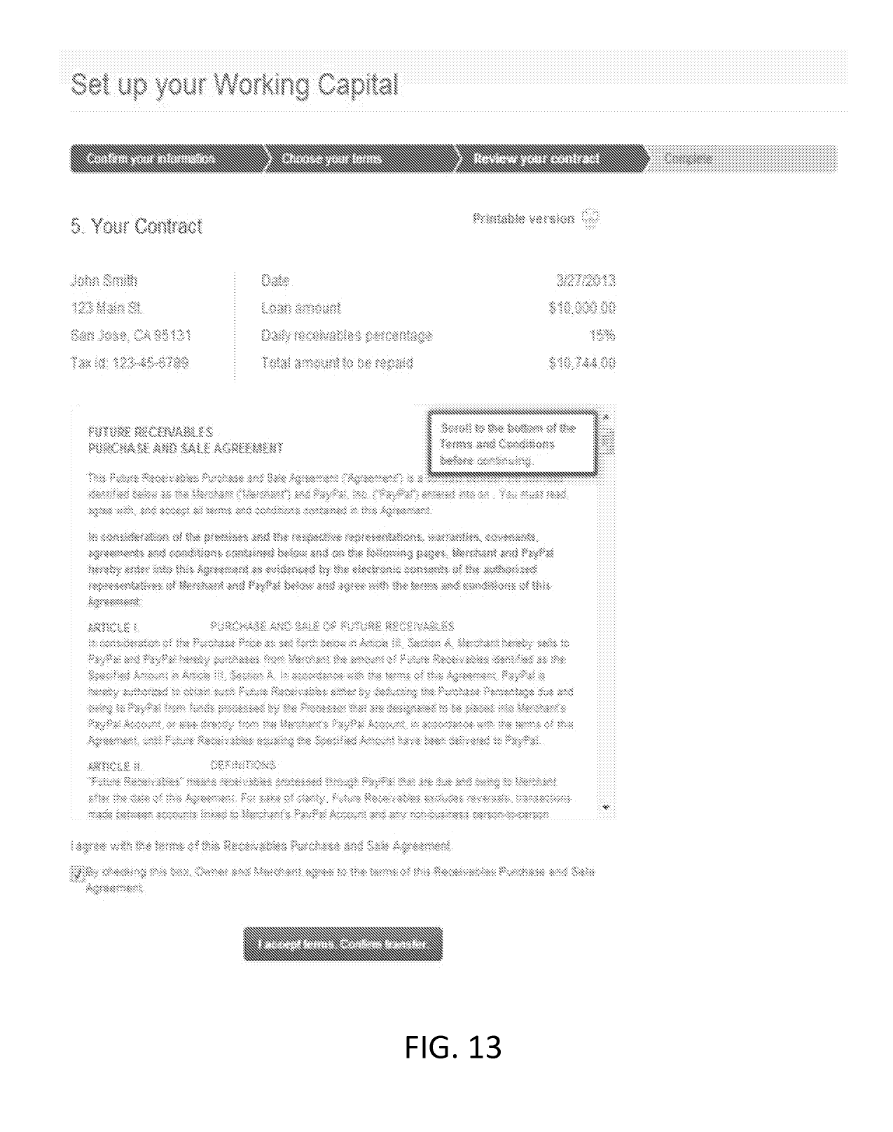

Once the borrower confirms the loan terms, payment provider server 170 may generate a loan contract based on the selected loan terms, as shown in FIG. 13. In the contract, the borrower agrees to allow the payment service provider to automatically deduct a percentage of the borrower's future sales revenue for repayment to the loan until the loan is paid off. Other terms and conditions of the loan also may be included in the contract, such as that the borrower will continue to use the payment service provider for future sales transactions and will not divert the sales transactions away from the payment service provider. The borrower is requested to confirm and accept the terms of the loan.

At step 210, the payment service provider may issue the loan funds to the borrower. For example, the loan funds may be deposited directly into the borrower's payment or merchant account. The loan approval process may take only a few minutes, because the payment service provider already has the credentials of the borrower required for loan approval and may make a determination for approval in a fast manner. After the loan funds have been issued, payment provider server 170 may send a message, via email or text messaging, to the borrower informing the borrower that the loan funds have been deposited to the borrower's account. Thus, the borrower may use the loan funds for his or her business. The repayment may begin after the loan funds are deposited.

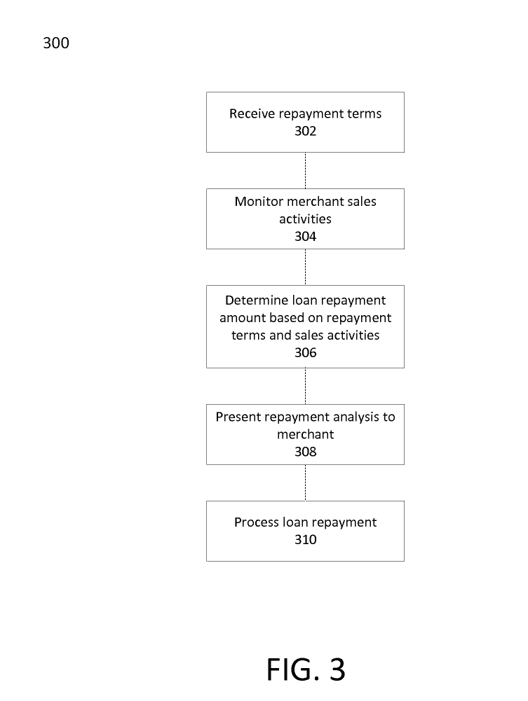

FIG. 3 illustrates a process 300 for automated loan repayments according to an embodiment of the invention. After the loan application is approved and the loan funds are issued to the borrower, the loan repayment process may begin. At step 302, payment provider server 170 may receive or retrieve repayment terms as agreed to during the loan application process. The repayment terms may indicate the frequency of payment, percentage of sales revenue to be deducted as payment, and the total loan amount including the one-time loan fee. The repayment frequency may be every day, every two days, every week, every two weeks, every month, or any other time period agreed to by the borrower and payment service provider.

At step 304, payment provider server 170 may monitor the borrower's transactions for sales activities. Sales activities may include all transactions except for fund transfers from a linked account of the borrower's account, personal payments, chargebacks, or the like that are not transactions related to a customer's purchase at the merchant borrower. The sales transaction amount may include taxes and shipping.

At step 306, payment provider server 170 may determine loan repayment amount for each repayment period based on the sales transactions. In particular, payment provider server 170 may aggregate the sales transactions during a repayment period to determine total sales revenue for that repayment period. Based on the loan terms, payment provider server 170 may determine a percentage of the total sales revenue as the repayment amount for that repayment period. For example, if the borrower has sales revenue of $1,000 on Monday and the loan terms indicate that 15% of the daily sales revenue is to be deducted for loan repayment, the payment service provider may determine that $150 of Monday's sales revenue is to be used for loan repayment. Payment provider server 170 may deduct $150 from the borrower's payment or merchant account on Tuesday. Payment provider server 170 may implement the repayment automatically. Thus, there is no need for the borrower to spend time and effort in determining the correct repayment amount and making the repayment.

If the borrower has spent the sales revenue such that there is not sufficient funds in the merchant's account to be deducted for repayment, payment provider server 170 may remember the repayment amount for this repayment and deduct the repayment amount in the next repayment period or whenever sufficient fund becomes available in the merchant's account. For example, if the repayment amount is $150, but the merchant has only $50 left in the account, payment service provider may deduct $50 first and then deduct $100 as a catch-up repayment whenever $100 becomes available in the merchant's account. No late fee is imposed on the borrower. Nevertheless, when severe or persistent repayment avoidance is observed by the payment service provider, the loan may be canceled and the remaining balance of the loan may become due immediately.

Other conditions that may be considered defaults on the loan include: borrower stops using the payment service provider as a form of payment, borrower deliberately directs sales volume away from the payment service provider, and/or frequently transferring sales proceeds out of the merchant account before the automated repayment occurs. Payment provider server 170 may continuously monitor for these conditions. When one or more of these conditions are observed, payment service provider may notify the borrower and may begin the process of recalling the loan. Therefore, although there is no penalty for the merchant when sales activities have slowed, the merchant may not take deliberate action to avoid repayment, which is tied to sales that have occurred.

At step 308, the payment service provider may present a summary of loan repayment progress to the borrower. The summary may be presented to the borrower periodically or by the borrower's request. For example, an email or paper mail including the summary may be sent from the payment service provider to the borrower. The borrower also may log into an online loan account at payment service provider's website to review the summary.

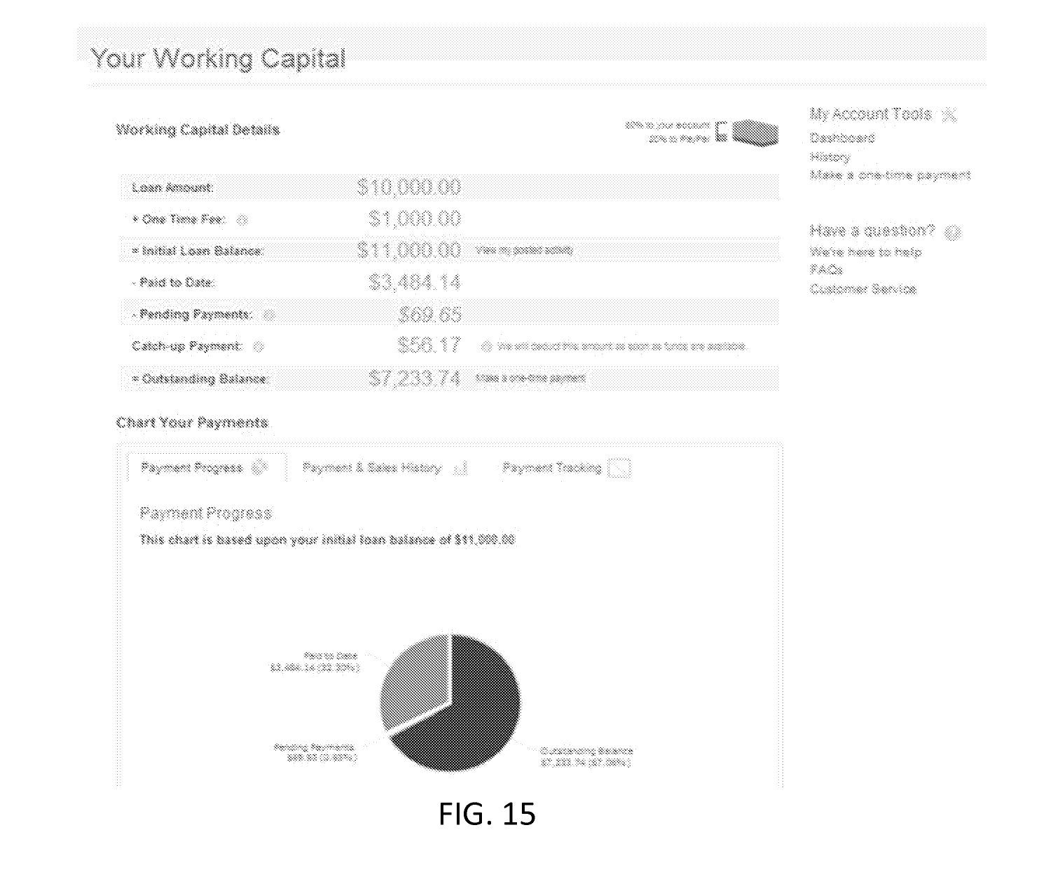

FIG. 15 illustrates an exemplary summary of loan repayment progress. The summary may include the original loan amount, the one-time loan fee, the initial loan balance, payments made to date, pending payments, catch-up payments, and the outstanding balance. Graphical charts, such as line, bar, or pie charts, may be used to provide a visual representation of the repayment progress. As shown in FIG. 15, a pie chart may be used to depict the outstanding balance v. amount paid. Other charts, such as bar chart or a line graph, may be used to depict repayment over time. The repayment trend also may be used to predict a payoff date when the entire loan balance is expected to be paid in full.

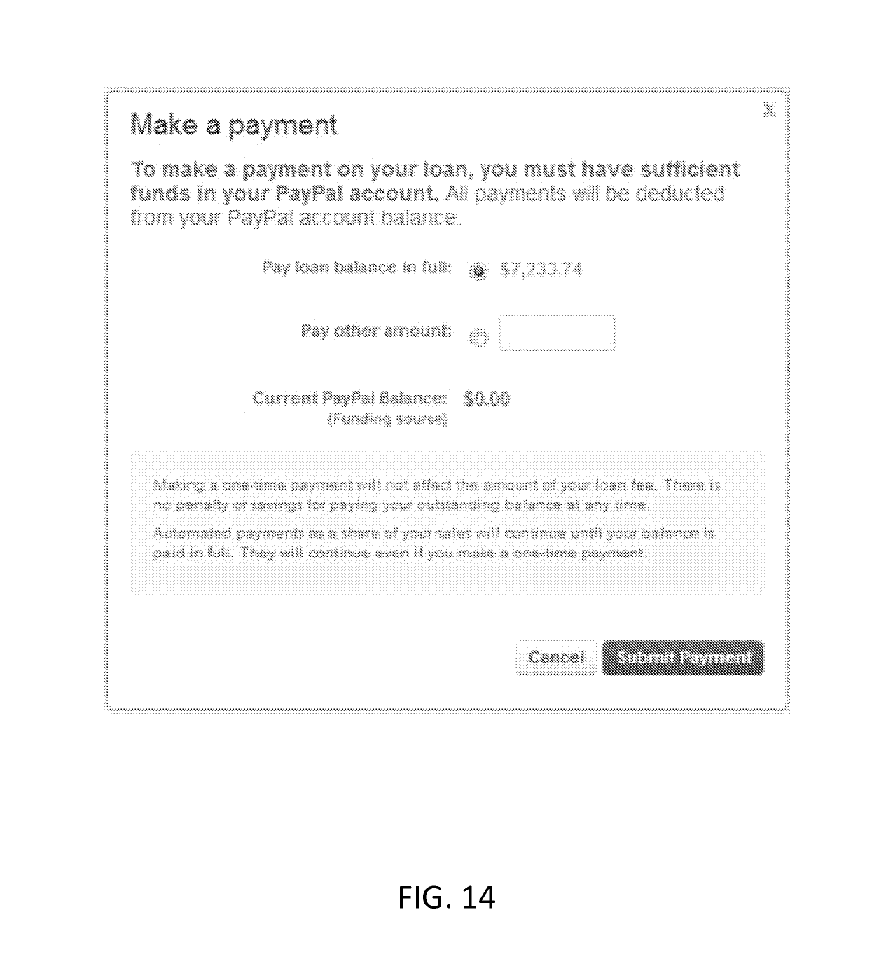

At step 310, the payment service provider may process the loan repayment. For example, the payment service provider may deduct the repayment amount from the borrower's merchant account and credit the repayment to the payment service provider. In some embodiments, the system may allow the borrower to make additional repayments without penalty. For example, as shown in FIG. 14, a user interface may be provided at payment service provider's online website or mobile app to receive additional repayments from borrowers. The user interface may allow a borrower to enter the additional amount to be paid and the funding source of the additional repayment. For example, the additional payment may be deducted from the borrower's payment account or other funding sources. Unless the additional payment pays off the loan balance, the additional payment may not affect the automated repayment process that occurs every repayment period. Thus, the automated repayment process may continue to be implemented.

The following is an exemplary scenario in which the above processes 200 and 300 may be implemented:

Lisa owns and operates a small flower shop called “Lisa's Floral” in a small town of Springfield. Lisa's Floral accepts PayPal as one of the methods of payment. Business has been good and Lisa has been contemplating the possibility of expanding her store. The estimated cost for the store expansion project is $15,000. Lisa has been talking to several banks about getting a loan for the store expansion project, but has not been getting good receptions from the banks.

PayPal recently begins to offer business loans to qualified PayPal merchants. Lisa's Floral has been a PayPal merchant for several years. PayPal analyzes Lisa's Floral's history of sales and transactions processed through PayPal and determines that Lisa's Floral is a merchant qualified for a business loan at PayPal. PayPal then sends an email to Lisa to introduce PayPal loan products to Lisa. The email may include an introduction to PayPal's loan product similar to that of FIG. 5. Lisa is interested in taking a business loan from PayPal and takes the product tour by visiting PayPal's loan product website. The product tour may be similar to that of FIGS. 6-9.

Lisa is excited by the possibility of getting a business loan to expand her store. As such, Lisa begins the loan application process at PayPal's loan website. Lisa logs into her merchant account at PayPal. PayPal accesses the account information at Lisa's Floral. Based on the sales history and payment transactions of Lisa's Floral, PayPal determines that Lisa has good customer rating and steady cash flow. In particular, PayPal determines that Lisa's Floral consistently has average annual sales revenue of about $150,000. Thus, PayPal determines that Lisa's Floral is qualified for a business loan of an amount up to $15,000. Lisa decides to take out a $15,000 business loan from PayPal.

PayPal then determines several loan options for the loan amount of $15,000. The options include different repayment arrangements such as deducting 10%, 15%, 20%, or 25% of sales revenue as repayment. Each of these repayment arrangements may have a different one-time loan fee. For example, the 10% repayment arrangement has a $900 one-time loan fee, the 15% repayment arrangement has a $800 one-time loan fee, the 20% repayment arrangement has a $700 one-time loan fee, and the 25% repayment arrangement has a $600 one-time loan fee. These repayment options are presented to Lisa for her selection. PayPal also determines the projected pay-off date for each of these options. For example, based on Lisa's current sales revenue, a projected pay-off date for the 10% repayment arrangement.

Lisa selects the 10% repayment arrangement. The final cost for the loan is $15,900. A borrower's agreement is generated based on Lisa's selection. Lisa agrees to the borrowing agreement. PayPal then proceeds to issue the loan of $15,000 to Lisa's Floral's merchant account. Thus, Lisa receives the business loan and is able to begin the store expansion project.

After the funds are issued to Lisa's Floral, PayPal begins to monitor sales payments received by Lisa's Floral's merchant account. 10% of daily sales payment is calculated and deducted from Lisa Floral's merchant for repayment to the loan. During the store expansion project, the sales revenue decreased due to construction at the store. Nevertheless, Lisa does not have to worry about making repayments, because the repayment amount is based on the amount of sales. When Lisa receives less sales, the repayment amount also is less. Even if Lisa's Floral does not make any sales on some days, no repayments are required for those days. After the store expansion project is completed, Lisa's Floral sees a tremendous increase in sales and the loan is quickly paid off due to the increase in sales revenue. Lisa is very pleased with PayPal's loan program and is planning her next business project.

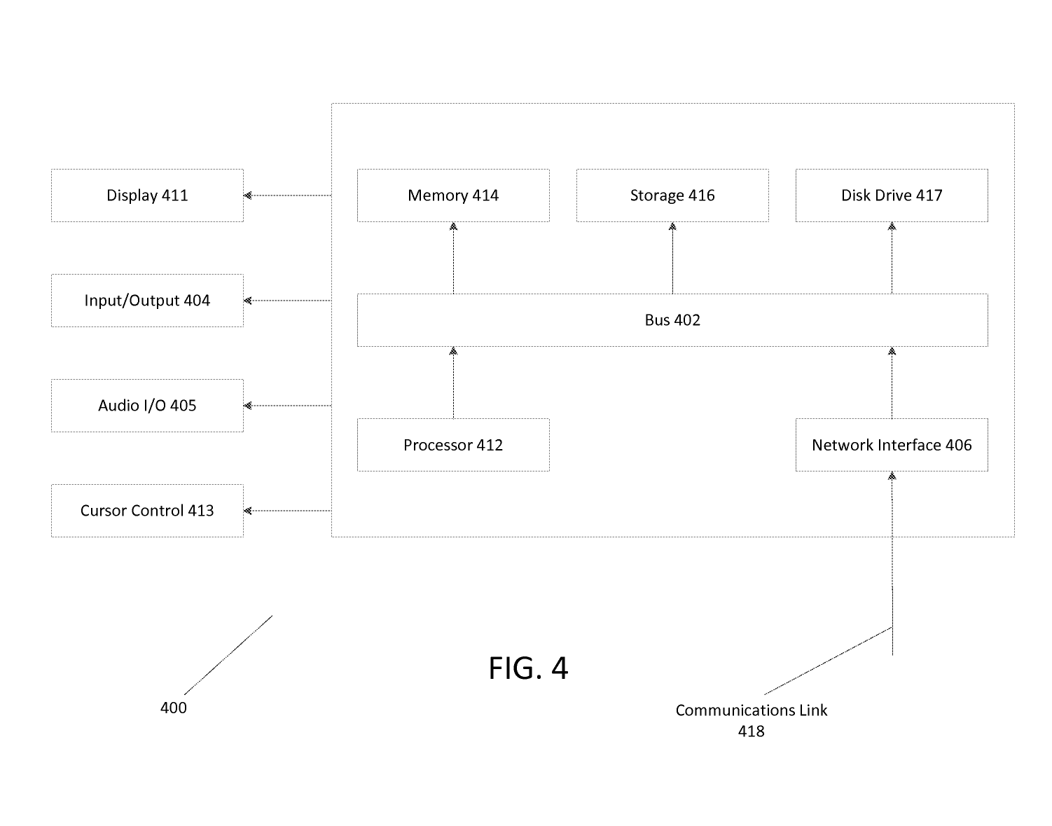

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system, comprising:
a non-transitory memory storing merchant account information, including merchant sales revenues processed through a payment provider; and
one or more hardware processors coupled to the memory and operable to read the instructions from the memory to perform the steps of:
determining a qualified loan amount based on sales revenue of a merchant processed through the payment provider;
receiving a loan amount selected by the merchant from within the qualified loan amount;
receiving a repayment arrangement selected by the merchant indicating a percentage of sales revenue to be used for repayment of the loan amount; and
collecting the percentage of the sales revenue of the merchant processed through the payment provider at periodic times for repayment of the loan amount.

2. The system of claim 1, wherein the qualified loan amount is a percentage of annual sales revenue of the merchant processed through the payment provider.

3. The system of claim 1, wherein the one or more hardware processors further perform the step of determining a one-time loan fee based on the repayment arrangement and the loan amount selected by the merchant.

4. The system of claim 1, wherein the repayment for each periodic time varies based on varying sales revenues for each periodic time.

5. The system of claim 1, wherein the periodic times are daily.

6. The system of claim 1, wherein the collecting comprises:
determining whether an account of the merchant contain sufficient fund for repayment for a present period;
determining a catch-up payment including a repayment amount missing in the present period; and
collecting the catch-up payment from the account in a subsequent period without penalty.

7. The system of claim 1, wherein the loan repayment has a non-fixed end date, which is contingent on varying repayment collected at each period.

8. A non-transitory machine-readable medium comprising a plurality of machine-readable instructions which, when executed by one or more processors, are adapted to cause the one or more processors to perform a method comprising:
determining a qualified loan amount based on sales revenue of a merchant processed through the payment provider;
receiving a loan amount selected by the merchant from within the qualified loan amount;
receiving a repayment arrangement selected by the merchant indicating a percentage of sales revenue to be used for repayment of the loan amount; and
collecting the percentage of the sales revenue of the merchant processed through the payment provider at periodic times for repayment of the loan amount.

9. The non-transitory machine-readable medium of claim 8, wherein the qualified loan amount is a percentage of annual sales revenue of the merchant processed through the payment provider.

10. The non-transitory machine-readable medium of claim 8, wherein the one or more hardware processors further perform the step of determining a one-time loan fee based on the repayment arrangement and the loan amount selected by the merchant.

11. The non-transitory machine-readable medium of claim 8, wherein the repayment for each periodic time varies based on varying sales revenues for each periodic time.

12. The non-transitory machine-readable medium of claim 8, wherein the periodic times are daily.

13. The non-transitory machine-readable medium of claim 8, wherein the collecting comprises:
determining whether an account of the merchant contain sufficient fund for repayment for a present period;
determining a catch-up payment including a repayment amount missing in the present period; and
collecting the catch-up payment from the account in a subsequent period without penalty.

14. The non-transitory machine-readable medium of claim 8, wherein the loan repayment has a non-fixed end date, which is contingent on varying repayment collected at each period.

15. A method comprising:
determining, electronically by a processor of a payment provider, a qualified loan amount based on sales revenue of a merchant processed through the payment provider;
receiving a loan amount selected by the merchant from within the qualified loan amount;
receiving a repayment arrangement selected by the merchant indicating a percentage of sales revenue to be used for repayment of the loan amount; and
collecting, electronically by the processor of the payment provider, the percentage of the sales revenue of the merchant processed through the payment provider at periodic times for repayment of the loan amount.

16. The method of claim 15, wherein the qualified loan amount is a percentage of annual sales revenue of the merchant processed through the payment provider.

17. The method of claim 15, wherein the one or more hardware processors further perform the step of determining a one-time loan fee based on the repayment arrangement and the loan amount selected by the merchant.

18. The method of claim 15, wherein the repayment for each periodic time varies based on varying sales revenues for each periodic time.

19. The method of claim 15, wherein the periodic times are daily.

20. The method of claim 15, wherein the collecting comprises:
determining whether an account of the merchant contain sufficient fund for repayment for a present period;
determining a catch-up payment including a repayment amount missing in the present period; and
collecting the catch-up payment from the account in a subsequent period without penalty.

21. The method of claim 15, wherein the loan repayment has a non-fixed end date, which is contingent on varying repayment collected at each period.
